(19) United States
(12) Patent Application Publication
(10) Pub. No.: US 2003/0080087 A1
(43) Pub. Date: May 1, 2003

(54) Process for surface modification of a micro fluid component

(76) Inventor: Martin Stelzle, Reutlingen (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/260,382

(22) Filed: Sep. 27, 2002

Related U.S. Application Data
(63) Continuation-in-part of application No. PCT/EP01/03032, filed on Mar. 16, 2001.

(30) Foreign Application Priority Data
Mar. 28, 2000 (DE) 10015380.1

(51) Int. Cl. B05D 3/00; B05D 1/18

(52) U.S. Cl. 216/27; 216/41; 216/67; 427/299; 427/430.1

(57) ABSTRACT

A method for the surface treatment of a micro fluid component is disclosed, comprising at least one channel for guiding a fluid, which terminates in an opening to which the fluid can be dispensed. The micro fluid component is coated on the external surface, whereby the external surface is treated with a surface-active fluid, whilst simultaneously the micro fluid component is flushed from the inside out with a non-surface-active fluid, for example, an inert gas, which escapes by means of the opening. Elective coating of the external surface can thus be achieved, in order to render the above hydrophobic, for example. Conversely the micro fluid component can be made selectively hydrophilic on the inner surface thereof, whilst the external surface is flushed in an inert gas.

### BACKGROUND OF THE INVENTION

The invention relates to a process for surface modification of a micro fluid component having at least one conduit for passing a fluid therethrough and having an orifice allowing to dispense fluid from the conduit to the outside.

The invention further relates to a micro fluid component having a plurality of elevated surface parts between which conduits for passing fluids therethrough are formed.

In biotechnology in laboratory operation and also in research micro fluid systems are necessary that are able to feed extremely small amounts of fluid and to dispense such fluid amounts in a precisely dosed manner. To this end piezoelectric pumps are known having an exit with very fine jets. In addition, under the designation “Top-spot” micro dispensing systems have become known, comprising a plurality of ascending pipes of small diameter in the order of 30 to 50 μm that are each connected to a reservoir by a conduit. Herein the individual ascending pipes fill independently by capillary action. By utilizing a pressure pulse, created for instance by a plunger, and transferring the pressure pulse by means of a film onto the ascending pipes, only the volume will be dispensed that is held in the ascending pipes. Thereby extremely small volumes being in the nanoliter region may be dispensed.

Due to the particular application, such micro fluid systems primarily are prepared from materials that are wetted by aqueous media, for instance from glass, silicon dioxide etc., or the materials are treated in such a way that the surfaces coming into contact with solutions have a hydrophilic character.

While the wetting of micro fluid channels or micro cuvettes of a system is a decisive condition for the proper functioning, the hydrophilic character at the outer surface presents a problem, in particular in the region of dispensing openings. Namely, there is a tendency to wet the surface in the region of the outgoing opening and even to form a drop. However, this impairs a proper dispensing of liquid or leads to a mixing of different solutions fed from adjacent dispensing openings, since the wetting may lead to the forming of bridges.

An additional problem may arise from the requirement that the inner surfaces, i.e. the walls of the conduits, shall have a hydrophilic characteristic, however, an adsorption of biomolecules on the walls shall be avoided.

In the prior art processes for modifying the wetting of micro fluid components are known, which utilize silane derivatives in liquid media, or which utilize chemical vapor deposition for modifying the surfaces to be treated.

However, such processes merely allow a modification of all surfaces in an equal manner. Thus the desired hydrophilic characteristic within the conduits may be reached, however, the drawbacks mentioned above are also present.

From U.S. Pat. No. 5,212,496 to Badesha et al. a coated ink jet print head is known. The ink jet print head comprises a plurality of channels, wherein the channels are capable of being filled with ink from an ink supply and wherein the channels terminate in nozzles on one surface of the print head, the surface being coated with a polyimide siloxane block copolymer. A water-repellent and ink-repellent coating of a thickness between 0.001 μm and about 10 μm comprising a polyimide-siloxane block copolymer is applied to the front surface of the print head. The ink-repellent coating can be applied to the print head array face by blowing high velocity filtered gas, such as air, nitrogen, hydrogen, carbon dioxide or an inert gas, through the array. Also the application of the coating to the print head array face from an intermediate transfer sheet, such as a flexible vinyl or plastic sheet, is disclosed. The coating material is first applied to the flexible transfer sheet, thereafter the wet surface of the transfer sheet is pressed onto the print head array surface, thus transferring some of the coating material to the print head front face.

While this method is suitable for preparing a coated ink jet print head, it presents difficulties when preparing micro fluid components of extremely small dimension.

From EP 0 882 593 A1 another method for forming a hydrophobic/hydrophilic front face of an ink jet print head is known. The method comprises the forming of a thin hydrophobic film over the front surface of the print head, and laser ablating portions of the hydrophobic film to expose an underlying hydrophilic surface, whereby the exposed surfaces form hydrophilic regions adjacent to the hydrophobic region of the non-ablated film adjacent to the nozzles of the print head.

Also this method may be suitable for a preparation of an ink jet print head, however cannot be applied to the preparation of extremely small micro fluid components, such as used in biotechnology.

### SUMMARY OF THE INVENTION

It is an object of the present invention to provide a process for surface modification of a micro fluid component having at least one conduit for passing a fluid therethrough and having an orifice allowing to dispense fluid from the conduit to the outside, which allows a selective surface modification of the outer surface of the micro fluid component and of the inner surface of the conduit.

It is a further object of the invention to provide a micro fluid component that can be prepared in very small dimensions and allows to dispense extremely small amounts of liquid from the orifices.

It is a further object of the invention to provide a process for the surface modification of a micro fluid component that avoids problems arising from extremely close adjacent orifices from which liquids may be dispensed.

It is a further object of the invention to provide a method for selective surface modification of a micro fluid component that comprises the immersing of the micro fluid component in a reaction fluid.

It is a further object of the invention to provide a process for surface modification of a micro fluid component that is particularly simple and can be applied for the treating of a large variety of micro fluid components.

It is still a further object of the invention to provide a process for surface modification of a micro fluid component having a flat surface and comprising a plurality of conduits that are separated by elevated wall structures and are open to the outside.

These and other objects of the present invention are achieved by cleaning the micro fluid component first preferably in a mixture comprising ammonia, hydrogen peroxide and water, rinsing the micro fluid components thereafter and drying at elevated temperature, subsequently mounting the micro fluid component to a fluid source and finally treating the micro fluid component with a surface active reaction fluid of hydrophobic modifying characteristic under a protective atmosphere while feeding an inert fluid through the conduits thereof.

A micro fluid component in this specification shall be regarded as any component having at least one conduit through which fluid can be dispensed to the outside. This may for instance be a micro pump or a micro cuvette of any dimension. The respective conduit may have any desired diameter, for instance in the region of roughly 10 to 200 μm. However also extremely small diameters in the order of 5 μm or less are possible.

The coating thickness at the inner surface or the outer surface of the micro fluid component is typically between 0.5 and 5 nanometers, preferably below 1 nanometer. At such a small coating thickness there is no significant modification of the geometry of the micro fluid component. Even the smallest conduits and nozzles in the micrometer range can thus be modified at the surface thereof, without impeding the correct geometry of the micro fluid component.

The coating thickness achieved thereby is typically between 0.5 and 5 nanometers, preferably below 1 nanometer. Such a thin coating has the advantage that the geometry of the micro fluid component is not altered significantly. Even nozzles and channels in the micrometer range can be modified in this way, without impairing the correct geometry of the micro fluid component.

Also by utilizing a suitable suction device for the reaction solution any contamination of the outer surface can be avoided or reduced.

In this specification a surface active reaction fluid is regarded as a fluid having a surface modifying property. By contrast, a non surface active fluid is regarded as a fluid causing no modification of the surface. This may, in particular, be an inert gas, such as argon or any other noble or inert gas. The surface active reaction fluid may bind to the surface of the micro fluid component in a chemical or physical way and has a characteristic of modifying the properties of the surface, such as making it hydrophilic or hydrophobic or by making it impairing an adsorption of biomolecules.

If an inert gas is fed through the conduits of the micro fluid component, then the inert gas will be dispensed from the orifices of the conduits and will rise to the surface of the reaction solution, while the micro fluid component is immersed therein. Thereby a precise separation between the outer surface to be treated and the inner surfaces of the micro fluid component not to be treated is made possible.

The surface active reaction fluid may be a reaction liquid or gas containing reactive species that modifies the outer surface in a hydrophobic way, the reaction solution being a solution comprising a silane derivative. Thereby, in particular a silicon comprising outer surface of the micro fluid component, such as a glass surface, can be modified in a hydrophobic way.

For example a octadecyltrichlorosilane solution, preferably in dry hexane or dimethylformamide (DMF), may be utilized. E.g. a solution of roughly 0.5 to 5 vol.-% octadecyltrichlorosilane in dry hexane may be utilized.

According to a further embodiment of the invention the micro fluid component is immersed with its orifice or nozzle within the reaction liquid, while an inert gas is fed through the conduits of the micro fluid component, while stirring the reaction liquid during the treatment.

A stirring during the treatment ensures that no gas bubbles from reaction gas moving upwardly can rest on the outer surface which would impair the surface treatment in this region.

Preferably the micro fluid component is cleaned before the treatment in a mixture comprising 1 volume part of ammonia, 1 volume part of hydrogen peroxide and 5 volume parts of water, is rinsed thereafter with water and isopropanol, and dried thereafter at elevated temperature before the treatment with a surface active reaction fluid begins. After the treatment the micro fluid component is preferably rinsed, dried and processed at elevated temperature to complete the surface modification of its outer surface, which may be done for instance at roughly 120° C. under protective atmosphere.

According to an alternative embodiment of the invention a surface active reaction solution is fed through the conduits of the micro fluid component, the reaction solution being dispensed to the outside through the orifice or nozzle, while the micro fluid component is rinsed at the outer surface thereof with a non surface reactive fluid.

In this way a selective surface modification of the micro fluid component can be reached, namely by treating the inner surface of the channels of the micro fluid component, while the outer surface is not modified by this treatment.

In this way the wetting or adhesion characteristic of the inner surfaces of the micro fluid component can be modified in a suitable way, while the outer surface is not modified.

For instance the inner surface of the at least one channel may be treated with a reaction solution of hydrophilic modifying characteristic and/or with a reaction solution impairing the adsorption of biomolecules.

In this way on the one hand a good liquid transport through the conduit or conduits of the micro fluid component is reached, while it is avoided that biomolecules, such as protein molecules, are adsorbed on the inner surface thereof.

Herein the surface active fluid may again be a reaction liquid comprising a silane derivative.

In particular the reaction liquid may comprise polyethylene glycol silane or a 2-[methoxy(polyethylene-oxy)propyl]heptamethyltrisiloxane that is, preferably, dissolved in dry hexane or dimethylformamide (DMF). The solution may for instance have a concentration of roughly 0.5 to 5 vol.-% in hexane or DMF, wherein a concentration of 1% leads to particularly good results.

During selective coating of the micro fluid component, according to a further embodiment of the invention the component may be held under an inert gas under a pressure that is lower than the pressure under which the reaction liquid is dispensed from the orifices or nozzle. Thereby a homogeneous outflow of liquid from the orifice is facilitated and any surface modification not desired in the region of the orifice is impeded.

According to a preferred embodiment of the invention first the outer surface of the micro fluid component is treated with a surface active fluid, while the conduit or conduits are rinsed with a non surface active fluid. Thereafter, when the surface modification has been completed at the outer surface, and after completing an intermediate rinsing and drying step, the inner surface of the conduit or conduits is treated with a surface active reaction fluid.

The reaction fluid of hydrophobic modifying characteristic may be a silane comprising a hydrophobic functional group, for instance an alkyl chain which may be perfluorized, e.g. monofunctional (tridecafluoro-1,1,2,2-H-tetrahydrooctyl)dimethylchlorosilane etc. or may be trifunctional (tridecafluoro-1,1,2,2-H-tetrahydrooctyl)trichlorosilane), or may comprise hydrocarbon chains (e.g. trifunctional), such as hexadecyltrichlorosilane, octadecyltrichlorosilane etc., or may be monofunctional (dimethyl-hexadecyl-chlorosilane etc.). The reaction liquid may also comprise mixtures of long chained silanes with silanes having a small functional group (so called “backfilling”), e.g. dimethyldichlorosilane, trimethylchlorosilane, methyltrichlorosilane, (3,3,3-trifluoropropyl)trichlorosilane.

The reaction fluid may also comprise a silane with reactive groups (e.g. an amino group, such as 3-aminopropyltrimethoxysilane) for subsequent adding of further functional groups, such as polyethylene glycol derivatives (e.g. bis-epoxy-PEG, molecular weight 500-20000, preferably roughly 5000), the latter being preferred for preparing protein repellent coatings.

Particularly preferred is a method according to which first a long chained silane is deposited by bringing the micro fluid component into contact with a solution of the respective silane (while inert gas protects the inner surfaces against a penetration of reaction liquid). Thereafter the micro fluid component is coated with a solution of small functional groups, such as dimethyldichlorosilane (as mentioned before (backfilling)).

It is further preferred to prepare the surface active reaction fluid under protective atmosphere and also to perform the treatment under a protective atmosphere, such as in a glove box filled with an inert gas, to avoid that the reaction solution comes into contact with moisture which might lead to side reaction not desired, such as polymerization, the forming of oligomers of precipitations, etc.

According to a further embodiment of the invention the micro fluid component is fully coated in the very beginning, for instance by immersing in a respective reaction solution, such as mentioned above, or in a reactive gas or by pumping the reaction solution through the conduit or conduits.

Thereafter selected regions of the micro fluid component on which the coating shall be kept, are covered in a suitable way, for instance by applying an adhesive film, a lacquer etc.

The micro fluid component will then be etched, preferably in a plasma reactor, in which by means of coils or electrodes an R.F. plasma is effected that removes the coating in the regions not covered before. For fluorocarbon comprising coatings air (O₂, N₂) or clean O₂ plasms are suitable. Suitable gas compositions for other coatings are known to the person skilled in the art. After the etching step the coating can be removed and the fluid component can be immersed in deionized water or buffer solution to regenerate silanol groups (Si—OH) on the surfaces cleaned with plasma. Thereafter, the uncoated regions may be coated with another film, such as a protein repellent coating. In this case the coating applied in the very beginning serves as a mask, since the surfaces in this region are not chemically reactive. Thereby the addition of molecules of the second coating material is impeded effectively. Thus a structured, selective coating of the micro fluid component with two different coating types for a) controlling of the wetting and b) controlling/reduction of protein adsorption or selective binding of proteins or improvement of the wetting characteristics (e.g. of conduits, inner nozzle surfaces) may be effected.

According to a further embodiment of the invention a stamping treatment using a stamp with preferably a flat surface which is saturated with a surface active reaction fluid is utilized. The stamping method is particularly preferred to modify a surface of open channel structures, wherein a surface modification is only reached on the elevated surface regions, while the lower structure is not modified.

Herein first a stamp is prepared from a suitable polymer. The surface should be completely flat and free of contaminations. A silicon elastomer (such as Sylgard 184®, sold by Dow Corning) that swells in hexane, is suitable. The stamp should be cleaned as mentioned above and treated thereafter with a reaction solution as mentioned above, for instance by using a hexane solution of a silane of 0.01 to 5 vol.-%. Particularly preferred is a concentration of 0.1 vol.-%. The solution should allow a homogenous treatment of the stamp and should lead to some kind of swelling. Further suitable solvents are toluol, dichloromethane, ethanol etc. The treatment of the stamp is preferably performed under protective atmosphere, for instance in a glove box. First the solution is applied to the surface of the stamp (for instance by dripping, painting, by immersing, by spinning etc.) so as to reach a homogenous application. The solvent is then evaporized, and an ultrathin film of the silane remains. The film is then brought into contact by stamping onto the micro fluid component only onto those parts that protrude therefrom. The reactive groups of the silane react with silanol groups of the micro fluid component. Thereafter the micro fluid component is removed from the protective atmosphere and is heat-treated preferably between 80 and 120° C. for 5 to 60 minutes.

It will be understood that the above-mentioned and following features of the invention are not limited to the given combinations, but are applicable in other combinations or taken alone without departing from the scope of the invention.

### BRIEF DESCRIPTION OF THE DRAWINGS

Further features and advantages of the invention will become apparent from the following description of the preferred embodiments taken in conjunction with the drawings. In the drawings:

FIG. 1 is a schematic representation of a partial section of a micro fluid component being immersed in a reaction solution, while being coated at the outer surface thereof;

FIG. 2 is a schematic representation of a part of the micro fluid component in the region of its orifice or nozzle, wherein a reaction liquid is fed through a conduit extending to the orifice, while the outer surface is immersed in a reaction container under a protective gas;

FIG. 3 is a schematic representation of an ion etching method for the preparation of a selective coating of a micro fluid component according to a further embodiment of the invention;

FIG. 4 is a schematic representation of a partial section of a micro fluid component according to FIG. 1 and a stamp for selective surface treatment according to another embodiment of the invention;

FIG. 5 is a front view of a fixture allowing the feeding of inert gas or reaction gas into the conduits of two micro fluid components while immersing same in a liquid;

FIG. 6 is a schematic representation of another embodiment of the invention in which a flat stamp is utilized for surface treating elevated portions of the micro fluid component;

FIG. 7 is a schematic representation of the micro fluid component according to FIG. 6 after pressing the stamp onto the surface thereof; and

FIG. 8 is a top view onto a micro fluid component having six channels designed as grooves in the surface of a silicon dioxide plate, the grooves leading into nozzles, wherein the surface of the plate comprises an ultrathin hydrophobic coating impeding an outflow of liquid from the grooves filled therewith.

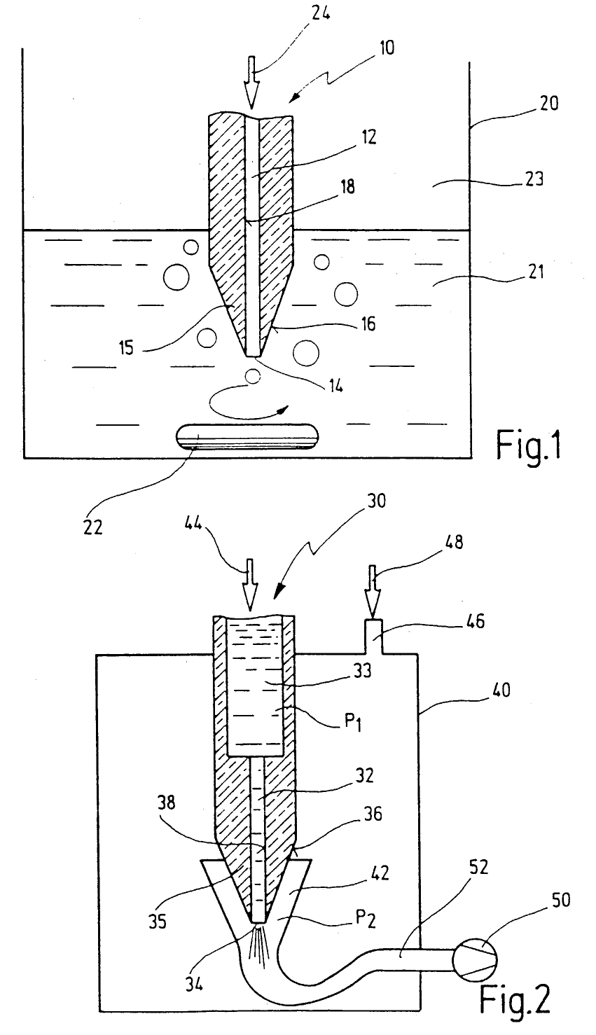

In FIG. 1 a partial section of a micro fluid component, designated in total with numeral 10, is shown in the region of an orifice or nozzle 14 which is formed as a metering orifice. The micro fluid component 10 may for instance consist of glass and comprises a conduit 12 which yields into the orifice 14 to the outside at a tip 15. The micro fluid component 10 in the region of its tip 15 is immersed in a reaction liquid 21 which is held in a reaction container 20. The reaction container 20 may be closed at its upper side (not shown) so that above the liquid surface of the reaction solution 21 a protective atmosphere, e.g. argon, may be provided. To this end the reaction container 20 may be introduced in a glove box (not shown). At the bottom of the reaction container 20 a stirring device 22, such a magnetic stirrer, is provided.

Such an arrangement is suitable for selective coating of the outer surface 16 of the micro fluid component 10 which may be performed as follows:

A protective gas, such as argon, is fed through the conduit 12, as indicated by arrow 24, the gas emerging from the orifice 14 to the outside and sparkling upwardly through the reaction solution 21 in the form of bubbles.

The reaction solution 21 may for instance be a solution of octadecyltrichlorosilane of 1 vol.-%. In this reaction solution 21 the micro fluid component 10 is immersed with its tip 15 for roughly 15 minutes at room temperature, while continuously stirring and while continuing the feeding of inert gas through the conduit 12.

Since above the liquid surface of the reactive solution 21 also a protective gas atmosphere 23 is obtained, the drawbacks are avoided which usually arise from air in contact therewith.

After roughly 15 minutes the process is interrupted and the micro fluid component is rinsed in hexane to remove any rests of reaction solution. Thereafter, the hydrophobic modification of the outer surface 16 within the region of the tip 15 is completed by a heat treatment for roughly 30 minutes under protective gas at roughly 120° C.

In FIG. 2 is illustrated how a conduit 32 extending through a micro fluid component 30 and leading to the outside into an orifice 34 can be treated at its inner surface without a previous treatment of the outer surface 36 of the micro fluid component 30.

The micro fluid component 30 in FIG. 2 is shown merely schematically and comprises a dosing volume 33 within a glass body, the dosing volume leading into a channel 32 of smaller diameter that finally leads into the orifice 34 at the outer surface 36. The micro fluid component 30 is located in a reaction container 40, shown merely schematically and covered by a protective atmosphere, such as by an argon gas atmosphere. A reaction solution is fed into the conduit 32 via the dosing volume 33 of the micro fluid component and finally emerges from the orifice 34 in the form of a jet. As shown in FIG. 2, the orifice 34 may cooperate with a funnel-shaped support 42 within which the reaction solution 21 emerging from the orifice 34 is collected. This funnel-shaped support 42 or the funnel can be connected via a pipe 52 to a vacuum pump 50, to thereby allow a suction of the liquid and to effect a homogenous liquid jet at the same time, so that the outer surface 36 in the region of the tip 35 is contaminated thereby only to a small extent at the most.

The reaction container 40 further comprises a gas inlet 46, whereby inert gas can be supplied into the direction of arrow 48. The reaction solution 21 fed into the direction of arrow 44 merely modifies the micro fluid component 30 at the inner surface 38 thereof, while the outer surface 36 is not modified.

The reaction liquid may for instance be a 0.5 to 5 vol.-%, preferably a 1 vol.-% solution from 2-[methoxy(polyethyleneoxy)propyl]heptamethyltrisoloxane in dry hexane or DMF at room temperature. The treatment with this reaction solution is performed for roughly 15 minutes at room temperature. Thereafter the micro fluid component 30 is rinsed several times in dry hexane and dried thereafter. This is followed by an annealing at roughly 120° C. for roughly 30 minutes under protective gas, to complete the modification of the inner surface 38 of the channel 32 and of the remaining inner surfaces of the micro fluid component 30, respectively. Thereby the inner surfaces of the micro fluid component 30 are covered with a thin hydrophilic coating, the coating reducing simultaneously an unspecific adsorption of biomolecules.

Although it is possible, in principle, to merely apply such a coating to the inner surface 38, without previously coating the outer surface, as explained with reference to FIG. 1, preferably the micro fluid component is coated at its outer surface first, as explained above with reference to FIG. 1, and thereafter a coating of the inner surface is effected. Since the reactive groups become saturated during the coating of the outer surface, a further modification of the outer surface is impeded during the subsequent coating of the inner surface. In some cases the protective gas may be deleted, however better results can be reached under protective gas.

Preferably the micro fluid component is cleaned and dried before the treatment of the surface reactive fluid. To this end a particularly effective cleaning method can be employed which comprises an immersing for roughly 15 minutes at roughly 80° C. in a mixture of 1 volume part of ammonia, 1 volume part of hydrogen peroxide and 5 volume parts of water. Thereafter an effective rinsing with deionized water and isopropanol is performed, before a drying under nitrogen and infrared irradiation (IR lamp) is performed.

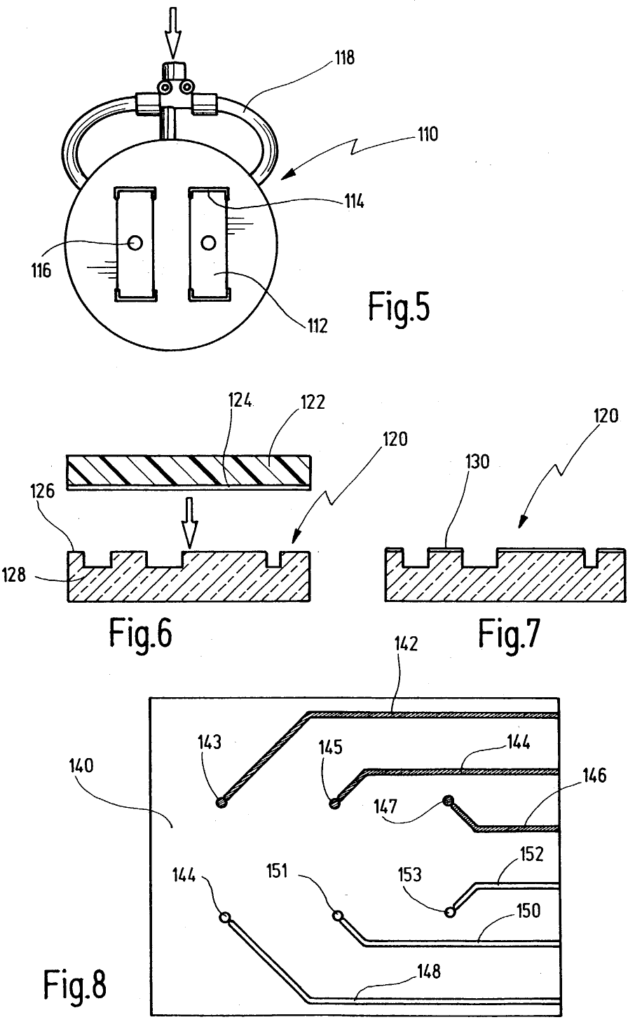

For the treatment by immersing in the surface reactive fluid the component may be supported in a fixture 110 such as shown in FIG. 5.

According to FIG. 5 the fixture 110 may comprise a plate made from polytetrafluoroethylene having recesses 114 for receiving the micro fluid components to be treated. In FIG. 5 the fixture 110 is designed to receive two “top spot 96” dosing chips comprising a plurality of 96 conduits forming nozzles on the outer surface thereof that are supplied through corresponding conduits designated at 116 with inert gas. Suitable sealings 114 are supported in the recesses 112 for isolating the chips on the lower side against the reaction fluid provided on the outer side. Gas pipes 118 are fixed to the fixture 110 allowing a feeding of an inert gas through the conduits at 116 via the respective conduits of the micro fluid components and through the nozzles thereof into the reaction fluid applied from the outside.

For the surface modification of micro fluid components in a hydrophobic way, preferably, a silane derivative having hydrophobic functional groups is utilized, such as:

perfluorized alkyl chains, e.g. monofunctional (1) (tridecafluoro-1,1,2,2-H-tetrahydrooctyl)dimethylchlorosilane etc., or trifunctional (2) (tridekafluoro-1,1,2,2-H-tetrahydrooctyl)trichlorosilane or with hydrocarbon chains, e.g. trifunctional (3), such as hexadecyltrichlorosilane, (4) octadecyltrichlorosilane etc., or monofunctional (5) (dimethyl-hexadecyl-chlorosilane etc.);

mixtures of long chained silanes with silanes having a small functional group (so called “backfilling”), e.g. (6) dimethyldichlorosilane, (7) trimethylchlorosilane, (8) methyltrichlorosilane, (9) (3,3,3-trifluoropropyl)trichlorosilane;

silanes with reactive groups (e.g. amino groups, such as (10) 3-aminopropyl-trimethoxysilane) for the subsequent adding of further functional groups, such as polyethylene glycol derivatives (e.g. (11) bis-epoxy-PEG, molecular weight 500-20000, preferably roughly 5000), to thereby prepare protein repellent coatings.

Particularly preferred is an embodiment of the invention according to which first a long chained silane, such as (1)-(5) is applied, by contacting the component to be coated with a solution of the respective silane (while a protective gas protects the inner surfaces of the conduits against penetrating of the reaction solution). Thereafter with a solution of silanes with small functional groups such as (6)-(9) defective spots or remaining uncoated surface regions are coated (so called “backfilling”).

As mentioned before, the coating may be performed by immersing the micro fluid component in a respective mixture, such as 110 according to FIG. 5, while a protective gas is fed through the conduits of the micro fluid component. Before immersing in the reaction solution, the inert gas flow is adjusted and continued, until the coating process including the subsequent rinsing steps has been fully completed. The appropriate gas pressure depends on the length and diameter of the conduits and may be decisive for the penetration of reaction solution into nozzles (usually between 0.2 to 0.8 bars at nozzle diameters of 50 to 80 μm). The coating process may take 5 to 120 minutes, preferably roughly 30 minutes. For particularly dense and stable coatings a coating time of up to 24 hours may be necessary. As mentioned before, preferably the coating is performed under protective gas, such as under argon gas, for instance in a glove box.

After the treatment with a surface reactive solution is completed, the micro fluid component is rinsed at its surface to remove any solution not having fully reacted and to avoid an uncontrolled reaction with environmental air moisture when removing the micro fluid component from the protective gas atmosphere. The rinsing may be formed by immersing in one or more containers with a suitable solvent or by spraying. The protective gas feeding through the conduits is continued during the rinsing process.

Suitable solvents for the reaction solution and for the subsequent rinsing step may for instance be dry hexane, toluol, hexadecane, dichloromethane, trichloromethane etc., or suitable mixtures.

After completion of the rinsing process the micro fluid components are preferably blown off with dry protective gas, such as nitrogen, to remove any rests of solvents. Finally the micro fluid components are heated to 80-120° C. to complete the binding of the silane molecules to the surface. It is particularly preferred to perform the step while being still in the fixture and while continuing the feeding of protective gas through the conduits, to thereby avoid the penetration of volatile media into the micro fluid component and to avoid contamination of the inner surfaces during the heat treatment.

As explained above, also the inner surface of the conduits of the micro fluid components may be surface-treated to obtain a hydrophilic or protein repellent surface characteristic.

To this end, it is possible to utilize polymeric surface reactive substances that bind quasi-irreversibly to the surface via adsorption. According to a further modification reaction methods comprising two or more steps may be utilized.

For the direct hydrophilic or protein repellent modification of surfaces solution or solutions of molecules may be utilized that directly bind to the surfaces to be modified quasi-irreversibly by adsorption. For instance a poly-(ethyleneglycol)-poly-(ethyleneimine)copolymer can be utilized in this regard. In this copolymer the poly-(ethyleneimine) (PEI) functions as a positively charged backbone that adsorbs quasi-irreversibly by electrostatic interaction to negatively charged surfaces, such as glass or silicon dioxide. This quasi-irreversible adsorption can normally be reached, if a molecular weight is utilized that may, e.g. be larger than 100 kD (kilo Dalton). Particularly preferred is a molecular weight of >1 MD for this polymeric backbone. In addition, this PEI comprises amino functions to which the mono- or bis-epoxy-poly-(ethyleneglycol)-derivative can be covalently bound, thus forming a PEG-PEI copolymer.

It should be clear that also other polymers or copolymers with a) chemical groups that have a charging for electrostatic coupling to a surface and b) side chains from a second polymer having the desired function with respect to wettability or reducing of a protein adsorption is within the scope of this invention.

Instead of the direct coupling of PEG derivatives via silane groups to glass or silicon dioxide surfaces also a multi-stage reaction can be performed. To this end, first, for instance, an aminopropyltrimethoxysilane is utilized to introduce amino groups into the surface. In the next step the surface is treated for instance with a mono- or bisepoxy-PEG, whereby the epoxy group reacts with the amino group, thus forming a covalent binding of the PEG to the surface.

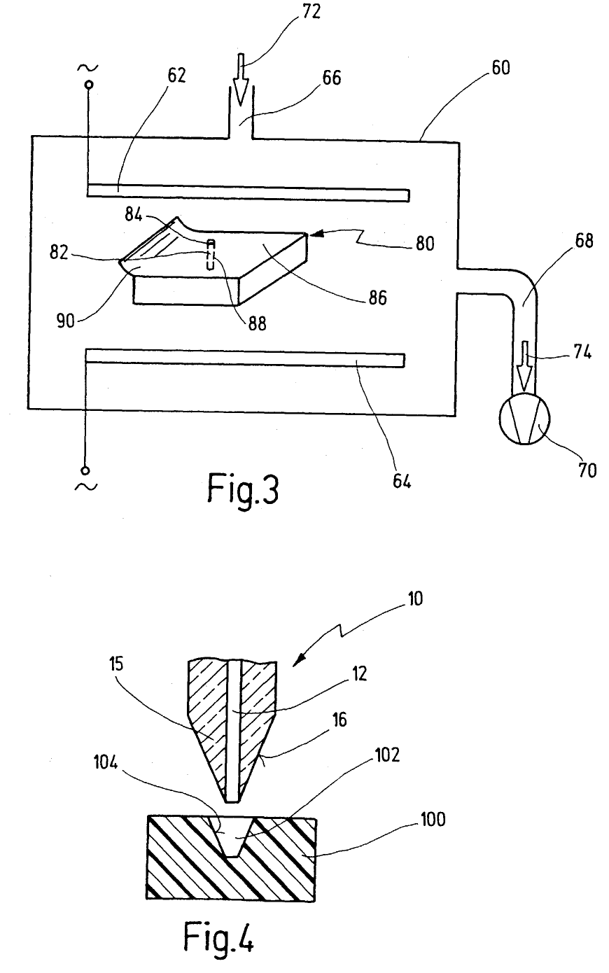

A further embodiment of the invention utilizing a masking procedure will now be explained with reference to FIG. 3.

In FIG. 3 a micro fluid component 80 is only shown merely schematically and comprises at least one orifice 84 in the outer surface 86 of the micro fluid component 80 into which a conduit 82 leads. From the orifice or nozzle 84 liquids or other fluids may be dispensed in a controlled dosed way.

To modify the outer surface 86 in the region of the orifice 84 in a hydrophobic way, first the complete micro fluid component is cleaned, dried, and fully coated, for instance by immersing in a reaction solution as explained before or by immersing in a reactive gas or by means of pumping a reaction liquid through the conduits.

Thereafter regions of the micro fluid component on which the coating shall remain are covered in a suitable way, for instance by applying an adhesive strip 90 or by applying a lacquer by spraying, painting or in another suitable way. Also the protective coating may be applied over a structured mask to thereby obtain a structured protective coating.

The micro fluid component 80 will then be inserted into a reaction chamber 60 for performing a gas etching step. To this end an argon/oxygen mixture or an argon/air mixture is fed through input conduit 66, such as indicated by arrow 72. A vacuum pump 70 is connected to an output conduit 68 for removing the reaction gas from the inner volume of the reaction container 60, as indicated by arrow 74. The vacuum pump 70 obtains a pressure of roughly 0.1 to 5 mbar within the reaction container 60.

Simultaneously RF-energy is applied via two RF-electrodes 62, 64 between which the micro fluid component 80 is supported in a fixture (not shown). By the RF-energy ions or gas radicals, respectively, are created, leading to an etching of the surfaces of the micro fluid component 80 not protectively covered. Already after a few minutes the hydrophobic coating applied previously is removed by the etching process. Thereby also the inner surface 88 of the conduit 82 is subjected to an etching attack, so that also the inner surface 88 is freed from any hydrophobic coating.

For carbon containing coatings air (O₂, N₂) or pure O₂ plasmas can be utilized. Suitable gas mixtures for the etching of other coating types are generally known in the art.

After completing of the etching step the protective cover or coating may be removed and the micro fluid component can be immersed in deionized water or in buffering solution to regenerate silanol groups (Si—OH) on the surfaces etched before.

If desired, the non-coated surfaces may be coated with an additional coating that may for instance be hydrophilic or protein repellent. In this case the coating applied before functions as a mask, since the surface is not chemically reactive in these regions. Thereby the addition of molecules of the second coating material is effectively impeded. A structured, selective coating of the micro fluid component with two different coating types may result therefrom for a) the control of wetting and b) the control/reduction of protein adsorption or selective binding of proteins or for the improvement of the wetting (for instance of conduits, of inner nozzle sides, of micro cuvettes etc.).

A further embodiment of the invention will now be explained with reference to FIGS. 4, 6 and 7.

For treating an outer surface 16 of the micro fluid component 10 according to FIG. 4 a stamp 100 is utilized which is made from silicon elastomer, such as Sylgard 184® which is sold by Dow Corning. The stamp 100 is made in the form of a tip, while the micro fluid component 10 comprises funnel-shaped recesses 102, the dimension of which is selected such that when pressing the stamp 100 onto the tip 15 only the forepart of tip 15 will come into contact with the surface of stamp 100 at a contact surface 104.

For the surface treatment of the micro fluid component 10 first the micro fluid component 10 is cleaned and dried as described above.

A reaction solution is then prepared with a suitable solvent. Particularly suited is an 0.01 to 5 vol.-%, preferably a solution of 0.1 vol.-% of a silane derivative (such as (1)-(5) mentioned before) in hexane. The solution should allow a homogenous application onto the stamp and shall also lead to some kind of swelling to thereby incorporate at least some of the reaction solution in the outer surface thereof. Other suitable solvents are toluol, dichloromethane, ethanol etc.

The coating of the stamp is performed under protective gas for instance in a glove box. First the solution is applied to the stamp surface by dripping, painting, by immersing, by spinning etc. to thereby reach a homogenous application. The solvent then evaporates, this leading to an ultrathin film of the silane derivative previously contained in the reactive solution. This film is then brought into contact with the micro fluid component by applying pressure, i.e. by stamping. Thereby, the reactive groups of the silane derivative react with silanol groups of the micro fluid component. A suitable positioning device (not shown) may be utilized for contacting the tip 15 of the micro fluid components 10 to be treated. Thereby the reactive molecules of the surface of the stamp 100 come into contact with the contact surface 104 on the outer surface 16 of the micro fluid component.

After a sufficient reaction time the stamp 100 is removed and a final treatment of the micro fluid component 10 is performed.

Thereafter the micro fluid component is removed from the protective atmosphere and is treated preferably between 80 and 120° C. for 5 to 60 minutes, preferably for roughly 30 minutes.

The result of the treatment will, inter alia, depend from the volatility of the solvent and of the reactant. If the volatility is too high, this may lead to the evaporation and modification also of adjacent regions not directly in contact with the stamp 100. The result will also depend from the reaction speed and the incubation time after which a reaction is started. The respective treatment parameters may be adjusted in dependence of the material to be treated in a suitable way.

It should be clear that the method explained before can also be modified, as explained before, in that during the contacting of the surface of the micro fluid component 10 with the stamp 100 a non-reactive fluid is fed through the conduit 12 of the micro fluid component. Thus the conduit 12 may be rinsed with argon that emerges from the opening at the tip 15. In this case the geometry of the stamp 100 must be modified in a suitable way, i.e. a suitable conduit must be included for feeding the inert gas therein. Also the form of the surface and the recess 102 of the stamp 100 may be adjusted to different surface forms of the micro fluid component to be treated.

Particularly preferred is a stamping method for the treating of flat micro fluid components having elevated or protruding parts as shown in FIGS. 6, 7 and 8.

According to FIGS. 6 and 7 a micro fluid component 120 has a flat surface wherein a plurality of recesses 128 is formed, thereby forming a plurality of elevated or protruding flat parts 126. The grooves 128 may form a plurality of conduits that are open to the outer surface of the micro fluid component 120. In this case the stamp 122 should be completely flat as shown in FIG. 6. The coating 124 is applied to the stamp 122 as previously explained. After the stamping procedure the elevated parts 126 of the micro fluid component 120 are covered by the reactive coating 130 as shown in FIG. 7.

In FIG. 8 an exemplary view of such a flat micro fluid component 140 is shown. The micro fluid component 140 may comprise a plurality of conduits 142, 144, 146, 148, 150, 152 formed as small grooves in the surface of the micro fluid component 140. These conduits 142-152 may end in orifices or nozzles 143, 145, 147, 149, 151, 153, respectively. By the application of a hydrophobic coating to the surface of the elevated parts of the micro fluid component 140 fluids may be guided in the conduits 142, 144, 146 as shown in the conduits 142, 144, 146 of FIG. 8 and will be impeded from emerging from the conduits.

1. A process for surface modification of a micro fluid component having at least one conduit for passing a fluid therethrough and having an orifice allowing to dispense fluid from the conduit to the outside, the process comprising:
cleaning the micro fluid component in a mixture comprising one volume part of ammonia, one volume part of hydrogen peroxide and five volume parts of water;
rinsing the micro fluid component with water and with isopropanol;
drying the micro fluid component at elevated temperature;
preparing a surface active reaction fluid of hydrophilic modifying characteristic from a polyethylenglycolsilane under a protective atmosphere;
mounting the micro fluid component to a fluid source; and
feeding the surface active reaction fluid of hydrophilic modifying characteristic through the conduit of the micro fluid component, while immersing same in an inert fluid.

2. A process for surface modification of a micro fluid component having at least one conduit for passing a fluid therethrough and having an orifice allowing to dispense fluid from the conduit to the outside, the process comprising:
cleaning the micro fluid component in a mixture comprising one volume part of ammonia, one volume part of hydrogen peroxide and five volume parts of water;
rinsing the micro fluid component with water and with isopropanol;
drying the micro fluid component at elevated temperature;
preparing a surface active reaction fluid under a protective atmosphere;
mounting the micro fluid component to a fluid source; and
treating the micro fluid component with the surface active reaction fluid of hydrophobic modifying characteristic under the protective atmosphere while feeding an inert fluid through the conduit.

3. A process for surface modification of a micro fluid component having at least one conduit for passing a fluid therethrough and having an orifice allowing to dispense fluid from the conduit to the outside, the process comprising:
cleaning the micro fluid component in a mixture comprising ammonia, hydrogen peroxide and water;
rinsing the micro fluid component with a solvent;
drying the micro fluid component;
preparing a surface active reaction fluid;
mounting the micro fluid component to a fluid source; and
treating the micro fluid component with the surface active reaction fluid under the protective atmosphere while feeding a non surface reactive fluid into the conduit.

4. A process for surface modification of a micro fluid component having at least one conduit for passing a fluid therethrough and having an orifice allowing to dispense fluid from the conduit to the outside, the process comprising:
cleaning the micro fluid component;
rinsing the micro fluid component with a solvent;
drying the micro fluid component;
preparing a surface active reaction fluid comprising a silane derivative;
mounting the micro fluid component to a fluid source; and
while feeding a non surface reactive fluid into the conduit, coating the micro fluid component with said surface active reaction fluid under the protective atmosphere, until a maximum coating thickness of less than 100 nanometers is reached.

5. The process of claim 4, wherein the micro fluid component is treated, until a maximum coating thickness of less than 10 nanometers is reached.

6. The process of claim 4, wherein said preparation step is performed under a protective atmosphere.

7. The process of claim 4, wherein said non surface reactive fluid is an inert gas.

8. The process of claim 6, wherein said protective atmosphere comprises an inert gas.

9. The process of claim 4, wherein the cleaning step is performed in a mixture containing one volume part of ammonia, one volume part of hydrogen peroxide and five volume parts of water.

10. The process of claim 4, wherein the cleaning and drying steps are performed at elevated temperatures.

11. The process of claim 4, wherein the cleaning step is performed at 60° C. to 100° C. for at least 5 minutes.

12. The process of claim 4, wherein a reaction liquid of hydrophobic modifying characteristic is utilized in said treating step.

13. The process of claim 4, wherein a reaction liquid comprising a silane derivative is utilized in said treating step.

14. The process of claim 12, wherein a reaction liquid comprising a silane derivative having at least one hydrophobic modifying functional group is utilized in said treating step.

15. The process of claim 12, wherein a reaction liquid is utilized comprising at least one component of the group formed by a silane derivative comprising perflourized alcyl chains, a silane derivative comprising hydrocarbon chains, a mixture of long chained silanes with silanes having a small functional group, a silane derivative comprising a reactive group for coupling further functional groups.

16. The process of claim 13, wherein a reaction liquid is utilized comprising at least one component of the group formed by (tridecaflouro-1,1,2,2-H-tetrahydrooctyl)-dimethylchlorosilane, (tridecaflouro-1,1,2,2-H-tetrahydrooctyl)trichlorosilane, hexadecyltrichlorosilane, octadecyltrichlorosilane, dimethyl-hexadecyl-chlorosilane, dimethyldichlorosilane, trimethylchlorosilane, methyltrichlorosilane, (3,3,3-trifluoropropyl)trichlorosilane, a silane derivative comprising a reactive amino group, to which a polyethylenglycol derivative is coupled.

17. The process of claim 16, wherein a first treating step is performed utilizing a silane derivative comprising a reactive amino group, and a second treating step utilizing a polyethylenglycol derivative is performed.

18. The process of claim 17, wherein said first treating step comprises a treating with 3-aminopropyltrimethoxysilan.

19. The process of claim 17, wherein the second treating step comprises a treating with bis-epoxy polyethylenglycol.

20. The process of claim 12, wherein the micro fluid component is first treated with a long chained silan derivative as a reaction fluid and is treated thereafter with a silane derivative comprising a small functional group.

21. The process of claim 4, wherein said micro fluid component is immersed in a surface active reaction liquid under a protective atmosphere and said reaction liquid is agitated while feeding said non surface reactive fluid into said conduit.

22. The process of claim 10, wherein said micro fluid component after said treating step is rinsed and dried at elevated temperature.

23. A process for surface modification of a micro fluid component having at least one conduit for passing a fluid therethrough and having an orifice allowing to dispense fluid from the conduit to the outside, the process comprising:
feeding through said conduit a surface reactive fluid having a hydrophilic modifying characteristic, while treating an outer surface of said micro fluid component with a surface active reaction fluid having hydrophobic modifying characteristic.

24. The process of claim 23, comprising, prior to said treating step, a cleaning of said micro fluid component in a mixture comprising ammonia, hydrogen peroxide and water, said cleaning step being followed by a drying step at elevated temperature.

25. A process for surface modification of a micro fluid component having at least one conduit for passing a fluid therethrough and having an orifice allowing to dispense fluid from the conduit to the outside, the process comprising:
preparing a surface active reaction fluid;
coating the micro fluid component at an outer surface thereof at least in a region surrounding the orifice utilizing said surface active reaction fluid;
covering selective regions of the outer surface of the micro fluid component with a protective cover; and
removing the coating previously applied in the regions not covered by the protective cover by etching the micro fluid component at an outer surface thereof.

26. The process of claim 25, wherein said covering step is a masking procedure comprising applying a lacquer over a mask covering the outer surface of the micro fluid component.

27. The process of claim 25, wherein said covering step comprises attaching a protective strip to the outer surface of said micro fluid component.

28. The process of claim 25, wherein said etching step comprises an ion etching process.

29. The process of claim 25, wherein said etching step comprises an ion etching process utilizing RF electrodes.

30. The process of claim 25, wherein said micro fluid component is cleaned prior to said coating step by immersing in a mixture comprising ammonia, hydrogen peroxide and water.

31. The process of claim 25, wherein said surface reaction fluid is prepared and applied to said micro fluid component under a protective atmoshere.

32. The process of claim 30, wherein after said cleaning step said micro fluid component is rinsed with a solvent and dried therafter.

33. The process of claim 30, wherein said cleaning step is performed in a mixture containing one volume part of ammonia, one volume part of hydrogen peroxide and five volume parts of water.

34. The process of claim 30, wherein said cleaning and drying steps are performed at elevated temperatures.

35. The process of claim 25, wherein a reaction liquid of hydrophobic modifying characteristic is utilized in said coating step.

36. The process of claim 25, wherein a reaction liquid comprising a silane derivative is utilized in said coating step.

37. The process of claim 25, wherein a reaction liquid comprising a silane derivative having at least one hydrophobic modifying functional group is utilized in said treating step.

38. A process for surface modification of a micro fluid component having at least one conduit for passing a fluid therethrough and having an orifice allowing to dispense fluid from the conduit to the outside, the process comprising:
cleaning the micro fluid component;
rinsing the micro fluid component with a solvent;
drying the micro fluid component;
preparing a surface active reaction fluid comprising a silane derivative;
mounting the micro fluid component to a fluid source; and
treating the micro fluid component by feeding a surface reactive fluid of hydrophilic characteristic into the conduit, while immersing an outer surface of said micro fluid component in a non surface reactive fluid.

39. The process of claim 38, wherein an inert gas is utilized as said non surface reactive fluid.

40. A process for surface modification of a micro fluid component having at least one conduit for passing a fluid therethrough and having an orifice allowing to dispense fluid from the conduit to the outside, the process comprising:
cleaning the micro fluid component;
rinsing the micro fluid component with a solvent;
drying the micro fluid component;
preparing a surface active reaction fluid comprising a silane derivative;
mounting the micro fluid component to a fluid source; and
treating the micro fluid component by feeding a surface reactive fluid of biomolecule repellant characteristic into the conduit, while immersing an outer surface of said micro fluid component in a non surface reactive fluid.

41. The process of claim 38 or 39, wherein a polyethylenglycolsilane is utilized as reaction fluid.

42. The process of claim 40, wherein a solution of reaction fluid of 2-[methoxy(polyethylenoxy)propyl]heptamethyltrisiloxane in a solvent is utilized as reaction fluid.

43. The process of claim 40, wherein a solution of molecules is utilized as reaction fluid which binds to a surface of said micro fluid component by adsorption.

44. The process of claim 43, wherein a solution of poly(ethylenglycol)-poly-(ethlenimine) copolymer is utilized as reaction fluid.

45. The process of claim 38, wherein said hydrophilic treatment of said conduit is achieved by a two-step-procedure by first feeding a reaction fluid through said conduit for providing epoxy groups at an inner surface thereof, and by feeding a second reactive fluid selected from the group formed by a mono-amino-polyethylenglycol and a bis-amino-polyethylenglycol thereafter through said conduit for reacting with said epoxy groups to form a polyethylenglycol bound by a covalent binding to said inner surface.

46. The process of claim 45, wherein first an aminopropyl-trimethoxysilane is fed as said first reaction fluid, and wherein a polyethylenglycol selected from the group formed by mono-epoxy-polyethylenglycol and bis-epoxy-polyethylenglycol is fed thereafter.

47. A process for surface modification of a micro fluid component having a plurality of elevated surface parts:
preparing from a polymer a stamp having a flat surface;
cleaning the micro fluid component;
drying the micro fluid component at elevated temperature;
preparing a surface active reaction fluid in a solvent under a protective atmosphere;
treating said flat surface of said stamp with said surface active reaction fluid homogeneously under a protective atmosphere until said stamp at least partially absorbs said reaction fluid;
evaporating said solvent at least partially;
pressing said flat surface of said stamp onto said elevated parts of said micro fluid component under a protective atmosphere;
heat treating said micro fluid component.

48. The process of claim 47, wherein said solvent is selected from the group formed by a hexane solution, a toluol solution, a dichloromethane solution, and an ethanol solution.

49. The process of claim 48, wherein a silane derivative is dissolved in said solvent.

50. The process of claim 49, wherein a concentration of substantially 0.1 percent by volume of said silane derivative in said solvent is utilized as said surface active reaction fluid solution.

51. The process of claim 48, wherein said heat treatment is performed between 70° C. to 130° C. for at least five minutes.
